(19) United States
(12) Patent Application Publication
(10) Pub. No.: US 2006/0002474 A1
(43) Pub. Date: Jan. 5, 2006

(54) Efficient multi-block motion estimation for video compression

(76) Inventors: Oscar Chi-Lim Au, Hong Kong (HK); Andy Chang, Hong Kong (HK)

Correspondence Address: ELIZABETH CHIEN-HALE, 40087 MISSION BLVD. BOX 367, FREMONT, CA, 94539, US

(21) Appl. No.: 11/168,232

(22) Filed: Jun. 27, 2005

Related U.S. Application Data
(60) Provisional application No. 60/582,934, filed on Jun. 26, 2004.

(51) Int. Cl. H04B 1/66; H04N 11/02; H04N 11/04; H04N 7/12

(52) U.S. Cl. 375/240.16; 375/240.24; 375/240.12

(57) ABSTRACT

A novel method, system, and apparatus for efficient multi-block motion estimation in a digital signal compression and coding scheme. This invention selects only a few representative block sizes for motion estimation when certain favourable conditions occur, rather than using all available block sizes. This invention produces significantly reduced computational costs with virtually no sacrifice in visual quality and in bit-rate.

### CROSS-REFERENCE TO RELATED APPLICATION

This application claims the benefit of priority from previously filed provisional application entitled “Efficient Multi-Block Motion Estimation for Video Compression,” filed on Jun. 26, 2004, with Ser. No. 60/582,934, and the entire disclosure of which is herein incorporated by reference.

This application is related to previously filed application entitled “Efficient Multi-Frame Motion Estimation for Video Compression,” filed on Mar. 25, 2005, with Ser. No. 11/090,373, and the entire disclosure of which is herein incorporated by reference.

### BACKGROUND

1. Field of the Invention

This invention relates generally to digital signal compression, coding and representation; more particularly, it relates to a video compression, coding and representation system and device and related multi-frame motion estimation methods.

2. Description of Related Art

Video communication, whether it is for television, teleconferencing, or other applications, typically transmits a stream of video images, or frames, along with audio over a transmission channel for real time viewing and listening by a receiver. However, transmission channels frequently add corrupting noise and have limited bandwidth; for example, television channels are limited to 6 MHz. Various standards for compression of digital video have emerged and include H.261, MPEG-1, and MPEG-2, to the newer H.264 and MPEG-4.

Due to the huge size of the raw digital video data, or image sequences, compression becomes a necessity. There have been many important video compression standards, including the ISO/IEC MPEG-1, MPEG-2, MPEG-4 standards and the ITU-T H.261, H.263, H.263+, H.263++, H.264 standards. The ISO/IEC MPEG-1/2/4 standards are used extensively by the entertainment industry to distribute movies, digital video broadcast including video compact disk or VCD (MPEG-1), digital video disk or digital versatile disk or DVD (MPEG-2), recordable DVD (MPEG-2), digital video broadcast or DVB (MPEG-2), video-on-demand or VOD (MPEG-2), high definition television or HDTV in the US (MPEG-2), etc. Emerging applications such as HDTV (high-definition TV) and video over IP (Internet Protocol) using an ADSL (asymmetrical-digital-subscriber-line) connection represent a variety of bandwidth-hungry terrestrial-broadcast and wired applications. Moreover, the cost of broadcasting is increasing. As content distribution applications become more popular, it is becoming clear that the two-times-better compression than MPEG-2 is the most cost-effective way to provide content distributions.

MPEG-4 applies to transmission bit rates of 10 Kbps to 1 Mbps using a content-based coding approach with functionalities such as scalability, content-based manipulations, robustness even in error-prone environments such as packet loss in packet networks and bit errors in wireless networks, multimedia data access tools, improved coding efficiency, ability to encode both graphics and video, and improved random access. When the bandwidth of the channel increases, the coder can then transmit additional bits to improve the quality of the poorly coded objects or restore the missing objects. Part 10 of the MPEG-4 specification defines another video codec, referred to as AVC (Advanced Video Coding) or, in an ITU context, H.264, which effectively doubles the compression ratio of MPEG-2. It is suited for use in a variety of new applications including, but not limited to, new “high density” DVD formats and high definition TV broadcasting. Comparing with MPEG-2, MPEG-4 can achieve high quality video at lower bit rate, making it very suitable for video streaming over internet, digital wireless network (e.g. 3G network), multimedia messaging service (MMS standard from 3GPP), etc.

As a quick review of history of the past ITU-T H.261/3/4 standards designed for low-delay video phone and video conferencing systems. The early H.261 was designed to operate at bit rates of p*64 kbits, with p=1, 2, . . . , 31. The later H.263 is very successful and is widely used in video conferencing systems and in video streaming in broadband and in wireless network, including the multimedia messaging service (MMS) in 2.5G and 3G networks and beyond. The latest H.264 is currently the state-of-the-art video compression standard. MPEG decided to jointly develop H.264 with ITU-T in the framework of the Joint Video Team (JVT). The new standard is called H.264 in ITU-T and is called MPEG-4 Advance Video Coding (MPEG-4 AVC), or MPEG-4 Version 10 in ISO/IEC. Based on H.264, a related standard called the Audio Visual Standard (AVS) is currently under development in China. Other related standards may be under development.

H.264 has superior objective and subjective video quality over MPEG-1/2/4 and H.261/3. The basic encoding algorithm of H.264 is similar to H.263 or MPEG-4 except that integer 4×4 discrete cosine transform (DCT) is used instead of the traditional 8×8 DCT and there are additional features include intra prediction Mode for I-frames, multiple block sizes and multiple reference frames for motion estimation/compensation, quarter pixel accuracy for motion estimation, in-loop deblocking filter, context adaptive binary arithmetic coding, etc.

From a more general perspective, compression essentially identifies and eliminates redundancies in a signal; instructions are provided for reconstructing the bit stream into a picture when the bits are uncompressed. The basic types of redundancy are spatial, temporal, psycho-visual, and statistical. “Spatial redundancy” refers to the correlation between neighboring pixels in, for example, a flat background. “Temporal redundancy” refers to the correlation of a pixel's position between video frames. Psycho-visual redundancy uses the fact that the human eye is much more sensitive to changes in luminance than chrominance. Statistical redundancy reduces the size of a compressed signal by using a compact representation for elements that frequently recur in a video. H.264 is considered advanced in removing temporal redundancies, which constitute a significant percentage of all the video compression that one can achieve. Video-compression schemes today follow a common set of interactive operations. (1) segmenting the video frame into blocks of pixels, (2) estimating frame-to-frame motion of each block to identify temporal or spatial redundancy within the frame, (3) an algorithmic discrete cosine transform (DCT) to decorrelates the motion-compensated data to produce an expression with the lowest number of coefficients, thus reducing spatial redundancy, (4) quantizing the DCT coefficients based on a psycho-visual redundancy Model; (5) removing statistical redundancy using entropy coding then removes

In past MPEG, the DCT's are done on 8×8 blocks, and the motion prediction is done in the luminance (Y) channel on 16×16 blocks. For a 16×16 block in the current frame to be compressed, the encoder looks for a close match to that block in a previous or future frame. The DCT coefficients are quantized. Many of the coefficients end up being zero.

With MPEG there are three types of coded frames. “I” or intra frames are simply frames coded as individual still images; “P” or predicted frames are predicted from the most recently reconstructed I or P frame. Each macroblock in a P frame can either come with a vector and difference DCT coefficients for a close match in the last I or P, or it can just be “intra” coded if there was no good match. “B” or bidirectional frames are predicted from the closest two I or P frames, one in the past and one in the future. The encoder searches for matching blocks in those frames, and tries three different things to see which works best: using the forward vector, using the backward vector, and averaging the two blocks from the future and past frames and subtracting the result from the block being coded.

An important component of motion estimation is the concept of motion vector-a pair of numbers representing the displacement between a macroblock in the current frame and a macroblock in the reference frame. The two numbers represent the horizontal and vertical offsets as measured from the upper left pixel of a macroblock. A positive number indicates right and down, and a negative number indicates left and up. Motion estimation is performed by searching for a good match for a block from the current frame in a previously coded frame. The resulting coded picture is a P-frame. The estimate may also involve combining pixels resulting from the search of two frames.

In particular, H.264 allows the encoder to use up to seven different block sizes or “Modes” (16×16, 16×8, 8×16, 8×8, 8×4, 4×8, 4×4) for motion estimation and motion compensation as shown in FIG. 1. In FIG. 1, Mode 1 (101) uses one 16×16 macroblockblock and one motion vector. Mode 2 (102) refers to the Mode wherein two 16×8 blocks are stacked one on top of the other and it has two motion vectors. Mode 3 (103) is the Mode where the macroblock is divided into two side-by-side 8×16 blocks with again two motion vectors. Under Mode 4 (104) there are four 8×8 blocks with four motion vectors. In Mode 5 (105) the macroblock is divided into eight 4×8 blocks with eight motion vectors. In Mode 6 (106) there are eight 8×4 blocks with eight motion vectors. In Mode 7 (107), there are 16 4×4 blocks with sixteen motion vectors.

By using multiple block sizes, accuracy of prediction between the original image and the predicted image is increased because, for each macroblock, it is possible to contain more than one object and the objects may not move in the same direction, and having only one motion vector may not be enough to completely describe the motion of all objects in one macroblock. By using multi-block motion estimation, the macroblock will be segmented into smaller zones, and each zone will have a motion vector pointing to the best-matched zone in the proceeding frame.

To substantially improve the process, one method is to use subpixel motion estimation, which defines fractional pixels such as half-pixel, quarter-pixel, ⅛-pixel, 1/16-pixel, etc. Unlike MPEG-2, which offers half-pixel accuracy, H.264 uses quarter-pixel accuracy for both the horizontal and the vertical components of the motion vectors in all of the seven block-sizes or modes.

The motion estimation modules constitute a significant portion of the encoding complexity H.264. It is possible that, in a 16×16 macroblock, the four 8×8 blocks may use different combinations of Mode 4 (104), Mode 5 (105), Mode 6 (106) or Mode 7 (107) independently. However, the processing time increases linearly with the number of allowed block sizes used. This is because separate motion estimation needs to be performed for each block size in a straight-forward implementation. This brute-force full selection process (the examination of all seven block sizes) provides the best coding result but the seven-fold increase in computation is very high. In the process, the motion estimation for a particular block size may be brute force full search for all the block size, or it can also be any fast search such as 3-step-search, diamond search, hierarchical search or the Predictive Motion Vector Field Adaptive Search Technique (PMVFAST). Some typical mismatch measures used in motion estimation include the sum of absolute difference (SAD), the sum of square difference (SSD), the mean absolute difference (MAD), the mean square error (MSE), etc. The result of the motion estimation is the chosen block size and the corresponding displacement vector, the motion vector. In some advanced rate-distortion optimized systems such as some H.264 systems, the mismatch measure includes a Lagrange multiplier term to account for the different bit rate needed for encoding the motion vectors.

Given the current state of the art, there is a need for a novel method, apparatus, and system which provide a fast multiple block size motion estimation scheme which requires significantly reduced computational cost while achieving similar visual quality and bit-rate as the full selection process.

### SUMMARY

This invention provides an efficient motion estimation procedure for use in MPEG-4/H.264/AVS encoded system. Instead of searching through all the possible block sizes, an extremely computationally expensive process, the proposed scheme selects only a few representative block sizes for motion estimation when certain favourable situations occur. This is very useful for real-time applications, with the clear advantage that computational cost is reduced significantly with little sacrifice in terms of visual quality and bit rate.

Most importantly, it can be combined with other fast algorithms to achieve even higher computation reduction. This can, in turn, reduce the cost of software and hardware. It also can reduce the power consumption, extending the operating battery life of many portable devices in particular.

In general, a matching of a first image frame called “current frame” against a reference image frame called “reference frame” is performed, including:
defining regions called “macroblocks” (e.g. non-overlapping rectangular blocks of size 16×16) in the current frame and their corresponding locations (e.g. location of a macroblock may be its upper left corner within the current frame);
for each macroblock called “current macroblock” in the current frame, defining a search region (e.g. a search window of 32×32) in the reference frame, with each point called “search point” in the search region corresponding to a motion vector called “candidate motion vector” which is the relative displacement between the current macroblock and a candidate macroblock in the reference frame; search regions for different macroblock in the current frame may have different sizes and shape;
for each current macroblock, constructing a hierarchy called “Modes” or “levels” of possible subdivision of the macroblock into smaller non-overlapping regions or “sub-blocks.” The Modes are not restricted to the H.264 specification, and this can be more generally represented as “modes” or “levels” are enumerated such that level M has sub-blocks with smaller area than or equal to those of level N for M>N.
for each current macroblock in the current frame, performing a relatively elaborated search, which may be brute-force exhaustive search, or some fast search such as Predictive Motion Vector Field Adaptive Search Technique (PMVFAST) with respect to some mismatch measure for the lowest mode of subdivision of the macroblock (with only one and the largest sub-block); and then performing relatively simple search for the higher modes of macroblock subdivision with smaller sub-blocks (e.g. for a lower-level subblock, performing a local search such as small diamond search around the motion vector obtained in the higher level). In one implementation of the invention, relatively elaborated search for the lowest mode has integer-pixel precision. In another aspect, relatively elaborated search for the lowest mode has integer-pixel precision and after the integer-pixel motion vector with the smallest mismatch measure is chosen, a sub-pixel motion estimation, which may be full search or some fast search, is performed to refine the motion vector.
after the relatively elaborated search for the lowest mode, the best motion vector corresponding to the smallest mismatch measure (e.g. SAD or MSE) in the Mode is chosen for the macroblock and no further motion estimation is performed, provided the corresponding smallest mismatch measure is smaller than some threshold. In one implementation of the invention, threshold is the weighted average of the smallest mismatch measure of all past macroblocks that chose the lowest mode as the final mode. In one implementation of the invention, equal weight is given to all the past macroblocks that chose the lowest mode as the final mode. In another implementation of the invention, the threshold is a function of the smallest mismatch measure of the spatially neighbouring and temporally neighbouring macroblocks. if the smallest mismatch measure in the lowest mode is larger than the threshold, then relatively simple search is performed for some higher modes of macroblock subdivision while the other modes are skipped.

In another implementation of the invention, in the bottom-up aspect, motion estimation is performed on blocks with smaller block size, such as Mode 4 (104) 8×8 blocks, and then simplified motion estimation is performed on selected blocks with larger block sizes (e.g. 16×8, 8×16, 16×16). The simplified motion estimation may be different for different larger block sizes. In particular, motion estimation may be skipped completely for some block sizes. For example, motion estimation can be performed for 8×8 first and then simplified motion estimation for 16×8, 8×16 and 16×16. In another example, motion estimation can be performed for 4×4 first and then selectively for larger block size.

The Top-Down aspect can be combined with the Bottom-Up aspect. This is a general aspect of fast multiple block-size motion estimation in which, instead of starting at the top or the bottom in the hierarchy of modes, the process starts in the middle and to perform simple search for either or both the higher modes or the lower modes.

### BRIEF DESCRIPTION OF THE DRAWINGS

FIG. 1 illustrates the seven Modes of dividing a macroblock for motion compensation in H.264

FIG. 2 shows a flow chart depicting the steps of the top-down fast multi-block motion estimation method

FIG. 3 illustrates two ways of dividing a macroblock into two “half” regions

FIG. 4 illustrates the half-pixel motion locations around the integer location I

FIG. 5(a) shows a flow chart depicting the steps of the first approach to bottom-up fast multi-block motion estimation method

FIG. 5(b) shows a flow chart depicting the steps of an alternative approach to bottom-up fast multi-block motion estimation method

FIG. 6 demonstrates the distribution of differences between optimal Mode 1 (16×16) motion vectors and Mode 4 (8×8) optimal motion vectors

FIG. 7 illustrates an example of motion vector prediction in H.264

FIG. 8(a) and FIG. 8(b) demonstrate the directional segmentation prediction for Mode 3 (8×16) and Mode 2 (16×8)

FIG. 9 illustrates a complexity comparison between using a full search and one implementation of the FMBME approach

FIG. 10 shows a flow chart depicting the steps of an alternative approach to the fast multi-block motion estimation method

### DETAILED DESCRIPTION

The fast motion estimation process is mainly targeted for fast, low-delay and low cost software and hardware implementation of H.264, or MPEG4 AVC, or AVS, or related video coding standards or methods. Possible applications include digital cameras, digital camcorders, digital video recorders, set-top boxes, personal digital assistants (PDA), multimedia-enabled cellular phones (2.5G, 3G, and beyond), video conferencing systems, video-on-demand systems, wireless LAN devices, bluetooth applications, web servers, video streaming server in low or high bandwidth applications, video transcoders (converter from one format to another), and other visual communication systems not mentioned explicitly here.

The present invention seeks to provide new and useful multiple block-size motion estimation techniques for any current frame in H.264 or MPEG-4 AVC or AVS or related video coding. For the video, one picture element (pixel) may have one or more components such as the luminance component, the red, green, blue (RGB) components, the YUV components, the YCrCb components, the infra-red components, the X-ray or other components. Each component of a picture element is a symbol that can be represented as a number, which may be a natural number, an integer, a real number or even a complex number. In the case of natural numbers, they may be 12-bit, 8-bit, or any other bit resolution. While the pixels in video are 2-dimensional samples with rectangular sampling grid and uniform sampling period, the sampling grid does not need to be rectangular and the sampling period does not need to be uniform.

The method of this invention has several aspects, as generally outlined below:
1. a top-down aspect, performing search on blocks with larger block size and then selectively performing search on blocks with smaller block size;
2. a bottom-up aspect, performing search on blocks with smaller block size and then selectively performing search on blocks with larger block size;
3. a general aspect, performing search on blocks with a certain size and then selectively performing search on blocks with larger or smaller block size.
   The Top-Down Aspect

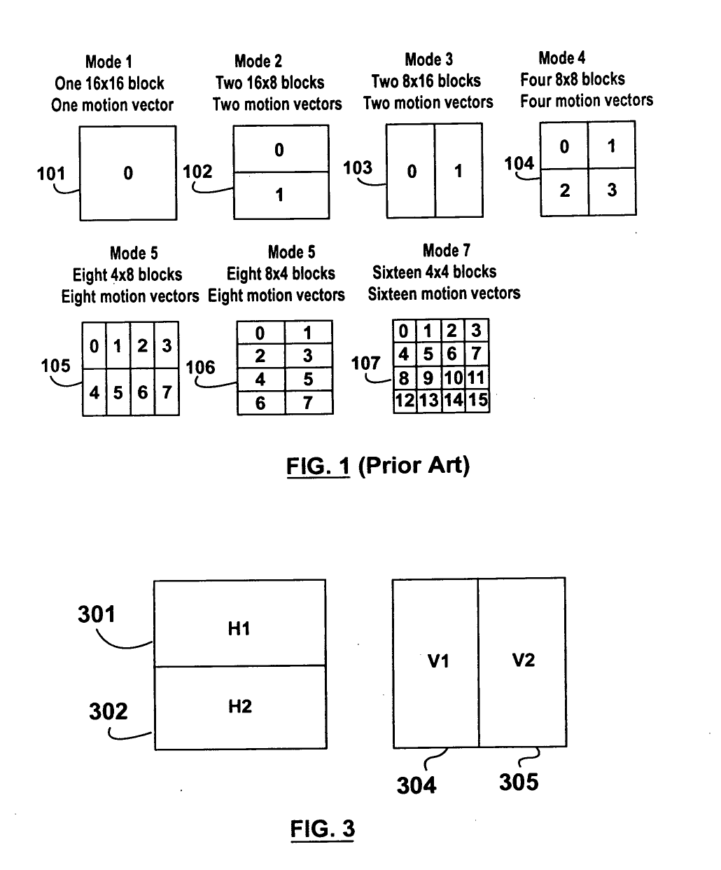

The modes of dividing a macroblock is shown in FIG. 1. In this top-down aspect, motion estimation is performed on blocks with larger block size, such as Mode 1 (101) 16×16, and then simplified motion estimation is performed on selected (can be all) blocks with smaller block sizes (e.g. 1 6×8 or 8×1 6 or 8×8). The simplified motion estimation may be different for different smaller block sizes. In particular, motion estimation may be skipped completely for some block sizes. Some examples of “larger” and “smaller” block sizes in relative terms are shown below in Table 1.

TABLE 1

| | Corresponding |
|---|---|
| Larger block size | smaller block sizes |
| 16 × 8 | 8 × 8, 8 × 4, 4 × 8, 4 × 4 |
| 8 × 8 | 8 × 4, 4 × 8, 4 × 4 |
| 4 × 8 | 4 × 4 |

The reason for skipping certain block sizes is that there is generally a significantly higher probability for a larger block size to be the optimal choice of block size than a smaller block size. If a larger block size is examined first and the performance is found to be good enough, there is no need to examine the smaller block sizes. As long as the larger block size has already been found to perform well, even if the smaller block size is to be examined for possibly better performance, they can be examined at reduced accuracy and complexity because good performance is already guaranteed by the larger block size.

The method of this invention, entitled Fast Multi-Block Motion Estimation (FMBME), uses one particular design for the case of larger block size being 16×16 and smaller block size being 16×8 and 8×16, and the design was presented in A. Chang, O. C. Au and Y. M. Yeung, “A Novel Approach to Fast Multi-Block Motion Estimation for H.264 Video Coding”, Proc. of IEEE Int. Conf. on Multimedia & Expo, Baltimore, Md., USA, vol. 1 pp. 105-108, July 2003, and also in master thesis by A. Chang, MPhil Thesis, Hong Kong University of Science and Technology, Hong Kong, China, 2003, entitled “Fast Multi-Frame and Multi-Block Selection for H.264 Video Coding Standard”. The entire contents of these papers are hereby incorporated by reference.

The main motivation is that typically most, up to 80%, of the macroblocks would choose the 16×16 Mode 1 (101) block as their final block size in most experiments. By performing Mode 1 motion estimation first and stopping when the SAD is small enough, the algorithm makes it possible to do minimal computation while capturing the optimal Mode (16×16, or Mode 1 (101)) in most of the cases. In the remaining cases, the smaller block sizes examined. For the sake of illustrations the Mode 2 (102) and Mode 3 (103), or 16×8 and 8×16 blocks, are used because these two Modes are the next most dominant and important Modes. It is often observed that even though different sub-blocks of a macroblock may have the same integer-pixel motion vector MV1 from Mode 1 (e.g. a motion vector of (3,4)), they may have different sub-pixel displacement (e.g. one with (2.75, 4) and another with (2.5, 4)) which can greatly affect the final SAD. It is further observed that the sub-pixel motion estimation can usually lead to significant SAD reduction compared with integer pixel motion estimation for the “correct” block size, but not so for the other block sizes.

In general, a matching of a first image frame called “current frame” against a reference image frame called “reference frame” is performed, including:
a. defining regions called “macroblocks” (e.g. non-overlapping rectangular blocks of size 16×16) in the current frame and their corresponding locations (e.g. location of a macroblock may be its upper left corner within the current frame);
b. for each macroblock called “current macroblock” in the current frame, defining a search region (e.g. a search window of 32×32) in the reference frame, with each point called “search point” in the search region corresponding to a motion vector called “candidate motion vector” which is the relative displacement between the current macroblock and a candidate macroblock in the reference frame; search regions for different macroblock in the current frame may have different sizes and shape;
c. for each current macroblock, constructing a hierarchy called “Modes” or “levels” of possible subdivision of the macroblock into smaller non-overlapping regions or “sub-blocks.” According to FIG. 1, a 16×16 macroblock can be subdivided into one 16×16 sub-block in Mode 1 (101), and two 16×8 sub-blocks in Mode 2 (102), and two 8×16 sub-blocks in Mode 3 (103), and four 8×8 sub-blocks in Mode 4 (104), and eight 8×4 sub-blocks in Mode 5 (105), and eight 4×8 sub-blocks in Mode 6 (106), and sixteen sub-blocks in Mode 7 (107), etc. The standard seven modes of H.264 are shown in FIG. 1. Of course, the Modes are not restricted to the H.264 specification, and this can be more generally represented as “modes” or “levels” are enumerated such that level M has sub-blocks with smaller area than or equal to those of level N for M>N.
d. for each current macroblock in the current frame, performing a relatively elaborated search, which may be brute-force exhaustive search, or some fast search such as Predictive Motion Vector Field Adaptive Search Technique (PMVFAST) with respect to some mismatch measure for the lowest mode of subdivision of the macroblock (with only one and the largest sub-block); and then performing relatively simple search for the higher modes of macroblock subdivision with smaller sub-blocks (e.g. for a lower-level subblock, performing a local search such as small diamond search around the motion vector obtained in the higher level). In one implementation of the invention, relatively elaborated search for the lowest mode has integer-pixel precision. In another aspect, relatively elaborated search for the lowest mode has integer-pixel precision and after the integer-pixel motion vector with the smallest mismatch measure is chosen, a sub-pixel motion estimation, which may be full search or some fast search, is performed to refine the motion vector.
e. after the relatively elaborated search for the lowest mode in part (d), the best motion vector corresponding to the smallest mismatch measure (e.g. SAD or MSE) in the Mode is chosen for the macroblock and no further motion estimation is performed, provided the corresponding smallest mismatch measure is smaller than some threshold. In one implementation of the invention, threshold is the weighted average of the smallest mismatch measure of all past macroblocks that chose the lowest mode as the final mode. In one implementation of the invention, equal weight is given to all the past macroblocks that chose the lowest mode as the final mode. In another implementation of the invention, the threshold is a function of the smallest mismatch measure of the spatially neighbouring and temporally neighbouring macroblocks. if the smallest mismatch measure in the lowest mode is larger than the threshold, then relatively simple search is performed for some higher modes of macroblock subdivision while the other modes are skipped.

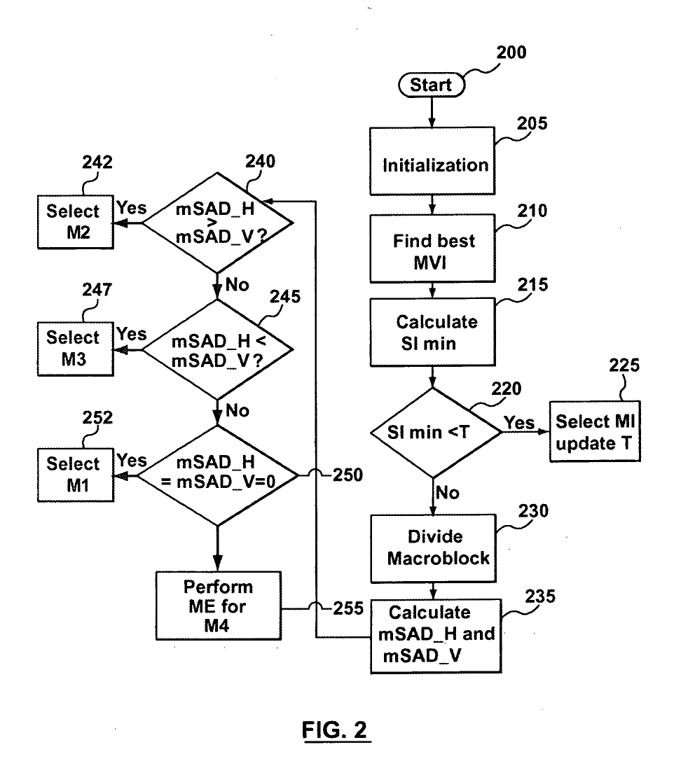

To explain the above process using more specific examples of modes used, the steps of the FMBME are shown in FIG. 2. Referring to FIG. 2, initialization (205) step is first under which three variables are defined as

| | |
|---|---|
| T: | threshold for early termination. |
| SAD1: | accumulated SAD of Mode 1. |
| N1: | accumulated number of macroblock used in Mode 1 |

and initialized as T=0, SAD1=0 and N1=0. Each macroblock is visited and the following is performed:

In step 210, an integer-pixel motion estimation is performed first for 16×16 Mode 1 (101) block using full search or some kind of fast search and calculate (215) the best SAD S1ₘᵢₙ of Mode 1 (101). Let the best SAD be S1ₘᵢₙ and the corresponding motion vector be MV1. The S1ₘᵢₙ value is used for early termination check (220). If S1ₘᵢₙ is less than a threshold T (220), the 16×16 block size (Mode 1) and the motion vector MV1 are chosen (225). The threshold used can be the historical average of S1ₘᵢₙ of all the Mode 1 blocks that choose the block size to be 16×16. After Mode 1 is chosen, threshold T is updated accordingly by the following three equations:
SAD1=SAD1+S1_{min,}
N1=N1+1,
T=SAD1/N1.

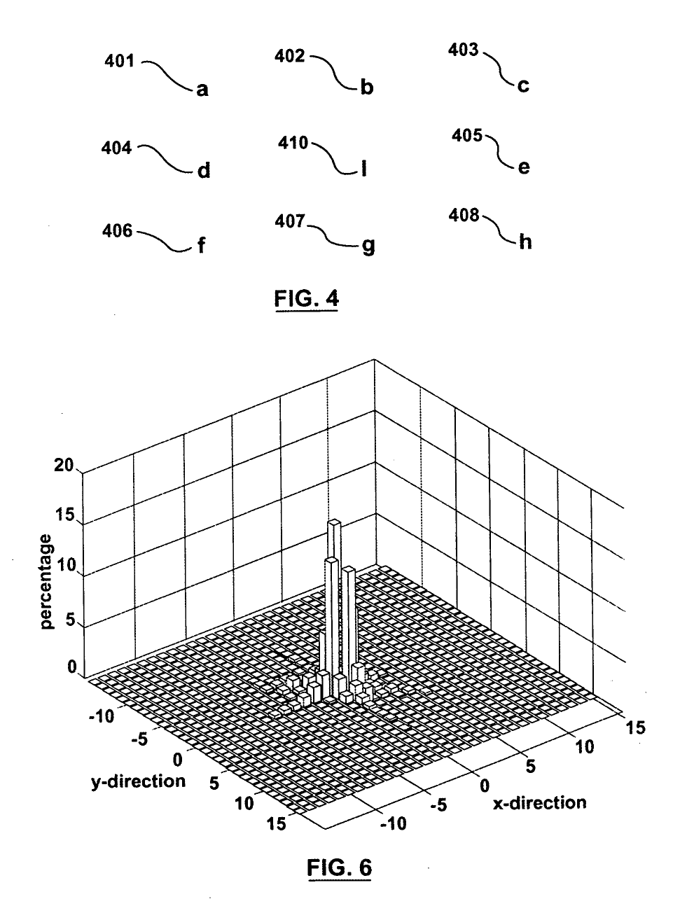

Other thresholds such as the average of S1ₘᵢₙ of all the Mode 1 blocks in some selected frames (e.g. some recent frames) can also be used. Depending on the SAD of the sub-pixel locations, motion estimation would be performed on either the 16×8 or 8×16 block size, or both. If the smallest mismatch measure of the best integer-pixel motion vector in the lowest mode is not smaller than the threshold, then a half-pixel motion estimation is performed for mode 2 (102) and mode 3 (103) around that best integer-pixel motion vector from mode 1 (101). For example, if S1ₘᵢₙ is not less than T, the 16×16 M1 (101) block is divided (230) into two modes of “half” regions as shown in FIG. 3: horizontally segmented H1 (301) and H2 and vertically segmented V1 (304) and V2 (305). The eight half pixel motion vectors around MV1 is shown in FIG. 4, where lower case letters a through h (401, 402, 403, 404, 405, 406, 407, 408) are ½-pel positions around the integer location I (410). Sub-pixel motion estimation is performed for each of the eight sub-pixel motion vectors around MV1. The maximum SAD difference between integer-pixel and half-pixel motion vectors for each “half” region is calculated (235) as

$$mSAD ( r ) = {max}_{p ∈ a - h} \{ SAD ( I , r ) - SAD ( p , r ) \}$$

where r is the region, and p is one of the eight ½-pel positions. Define
   mSAD_{—}H=mSAD(H1)+mSAD(H2)
   and
   mSAD_{—}V=mSAD(V1)+mSAD(V2)

If the sum of the two 16×8 sub-blocks is smaller than that of the two 8×1 6 sub-blocks (240), mode 2 is chosen (242) with the corresponding best sub-pixel motion vector. If the sum of the two 16×8 sub-blocks is larger than that of the two 8×16 sub-blocks (245), mode 3 is chosen (247) with the corresponding best sub-pixel motion vector. Otherwise, mode 4 (8×8) motion estimation is performed (255) also. If mSAD_H and mSAD_V are both 0 (250), then mode 1 is chosen (252) as the final block size and no further motion estimation is needed.

In one embodiment, one can simply choose mode 2, or mode 3 after rejecting mode 1 (when S1ₘᵢₙ>=T). However, in another embodiment the method calls for performing a comparison for the best choice among mode 1, mode 2, mode 3, and mode 4. The comparison can, for example, based on a cost function in the form of
cost=SAD+λ(Rate)
where SAD is the sum of the SAD of all the subblocks and Rate is the sum of the bit required to encode the mode and motion vectors of all the subblocks.

The proposed scheme was implemented in the H.264 with standard reference software TML9.0 which is downloadable at http://iphome.hhi.de/suchring/tml/download/old_tml/tml90.zip. Spiral Full Search is used in the motion estimation for each block size. Experimental results show that the average PSNR loss of the proposed FMBME using the top-down aspect alone is negligible small (0.023 dB) compared with full search of Mode 1, 2 and 3 (101, 102, and 103). Some experimental results are shown in Table 2, using QCIF sequences Coastguard, Stefan, Akiyo, and Forman. QCIF is an old video resolution name (¼ of the Common Intermediate Format resolution), and stands for “quarter common intermediate format.” Certain sequences such as “Foreman” and others are standard video QCIF sequences used for testing purposes can be found at various web sites, an example of which is http://www.steve.org/vceg.org/sequences.htm. As Table 2 shows, the average bit-rate increase of FMBME is 1.28%. In terms of computational complexity, instead of examining 3 block sizes in the full search, the proposed FMBME examines about 1.56 block sizes on the average.

TABLE 2
Comparison of PSNR, bit rate and complexity for H.264 and FMBME

| | | |
|---|---|---|
| Complexity | PSNR(dB) | Bit rate |

Coastguard

| | | | |
|---|---|---|---|
| H.264 | 417 × 10⁹ | 28.44 | 524856 |
| FMBME | 270 × 10⁹ | 28.40 | 531848 |
| Difference | 35.3% | −0.04 | −1.3% |

Akiyo

| | | | |
|---|---|---|---|
| H.264 | 204.6 × 10⁹ | 34.30 | 78984 |
| FMBME | 100.1 × 10⁹ | 34.29 | 78792 |
| Difference | 51.1% | −0.01 | 0.24% |

Stefan

| | | | |
|---|---|---|---|
| H.264 | 369.5 × 10⁹ | 27.49 | 1363536 |
| FMBME | 229.6 × 10⁹ | 27.45 | 1383944 |
| Difference | 37.8% | −0.04 | −1.5% |

Foreman

| | | | |
|---|---|---|---|
| H.264 | 342.9 × 10⁹ | 30.40 | 497072 |
| FMBME | 210.8 × 10⁹ | 30.34 | 502672 |
| Saved | 38.5% | −0.06 | −1.1% |

The above is only one example of a possible implementation for top-down FMBME. There can be many variations. For example, the threshold can be computed as a weighted average of S1ₘᵢₙ with possibly larger weight given to the spatially and/or temporally neighboring blocks. It can also be some linear or non-linear function of the weighted average. Alternatively, the threshold can be a function of S1ₘᵢₙ of only the spatially and/or temporally neighboring blocks. The threshold T can be functions of other quantities as well. The larger block size does not have to be 16×16 as it can be 32×32, 8×8 or other sizes. The smaller block size can be correspondingly smaller relative to the selected larger block size such as 8×4 or 4×8. And the mismatch does not have to be SAD. Other quantities such MSE can be used. While only 16×16, 16×8 and 8×1 6 are examined in this implementation of the FMBME, all the possible block sizes could have been examined sequentially, from large to small. For example, the top-down search can be performed iteratively to examine the 8×8 block size first and then the smaller block size such as 4×8, 8×4 and 4×4. In other words, for each 8×8, it can stop if the SAD is small enough. Otherwise, it can examine 8×4, 4×8, or both.

The Bottom-Up Aspect

In the bottom-up aspect, motion estimation is performed on blocks with smaller block size, such as Mode 4 (104) 8×8 blocks, and then simplified motion estimation is performed on selected blocks with larger block sizes (e.g. 16×8, 8×16, 16×16). This bottom-up aspect of fast multiple block size motion estimation will be referred to as FMBME2. Larger and smaller are relative terms are defined as in Table 1 above. The simplified motion estimation may be different for different larger block sizes. In particular, motion estimation may be skipped completely for some block sizes. For example, motion estimation can be performed for 8×8 first and then simplified motion estimation for 16×8, 8×16 and 16×16. In another example, motion estimation can be performed for 4×4 first and then selectively for larger block size.

Generally, regions called “macroblocks,” such as non-overlapping rectangular blocks of size 16×16 pels in the current frame and their corresponding locations (e.g. location of a macroblock may be identified by its upper left corner within the current frame) are defined. For each macroblock, called the current macroblock, in the current frame, defining a search region, such as a search window of 32×32, in the reference frame, with each point called “search point” in the search region corresponding to a motion vector called “candidate motion vector” which is the relative displacement between the current macroblock and a candidate macroblock in the reference frame; search regions for different macroblock in the current frame may have different sizes and shapes. In general terms,
f. for each current macroblock, constructing a hierarchy called “modes” or “levels” of possible subdivision of the macroblock into smaller non-overlapping regions or “sub-blocks. For example, referring to FIG. 1, a 16×16 macroblock can be subdivided into one 16×16 sub-block in mode 1 (101), and two 16×8 sub-blocks in mode 2 (102), and two 8×16 sub-blocks in mode 3 (103), and four 8×8 sub-blocks in mode 4 (104), and eight 8×4 sub-blocks in mode 5 (105), and eight 4×8 sub-blocks in mode 6 (106), and sixteen sub-blocks in mode 7 (107). The “modes” or “levels” are enumerated such that level M has sub-blocks with smaller area than or equal to those of level N for M>N;
g. for each current macroblock in the current frame, performing a relatively elaborated search (which may be brute-force exhaustive search or some fast search such as PMVFAST) with respect to some mismatch measure for a selected highest mode of subdivision of the macroblock (with smallest sub-blocks) and obtaining one or more representative motion vectors for each sub-block; and then performing relatively simple search for the lower modes of macroblock subdivision (with larger sub-blocks).

One implementation of the above general concept, called FMBME2-1 for the bottom-up aspect with the smaller block size being 8×8 and the larger block size being 16×16, 16×8 and 8×16, was presented in the paper A. Chang, O. C. Au, and Y. M. Yeung, “Fast Multi-block Selection for H.264 Video Coding”, in Proc. of IEEE Int. Sym. on Circuits and Systems, Vancouver, Canada, vol. 3, pp. 817-820, May 2004. It is also in the previously cited HKUST master thesis by A. Chang, MPhil Thesis, Hong Kong University of Science and Technology, Hong Kong, China, 2003, entitled “Fast Multi-Frame and Multi-Block Selection for H.264 Video Coding Standard”. The entire contents of these papers are hereby incorporated by reference.

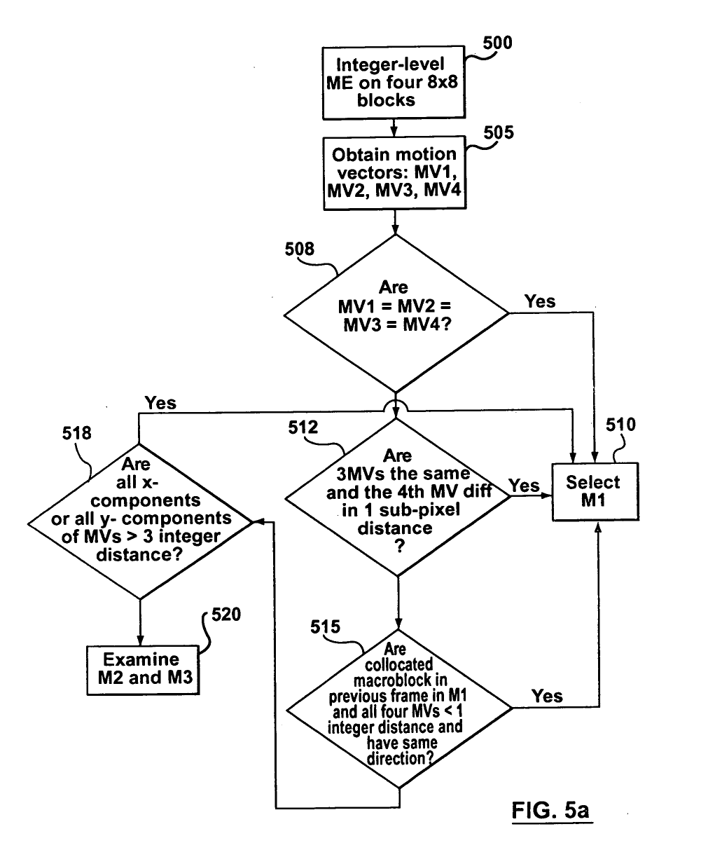

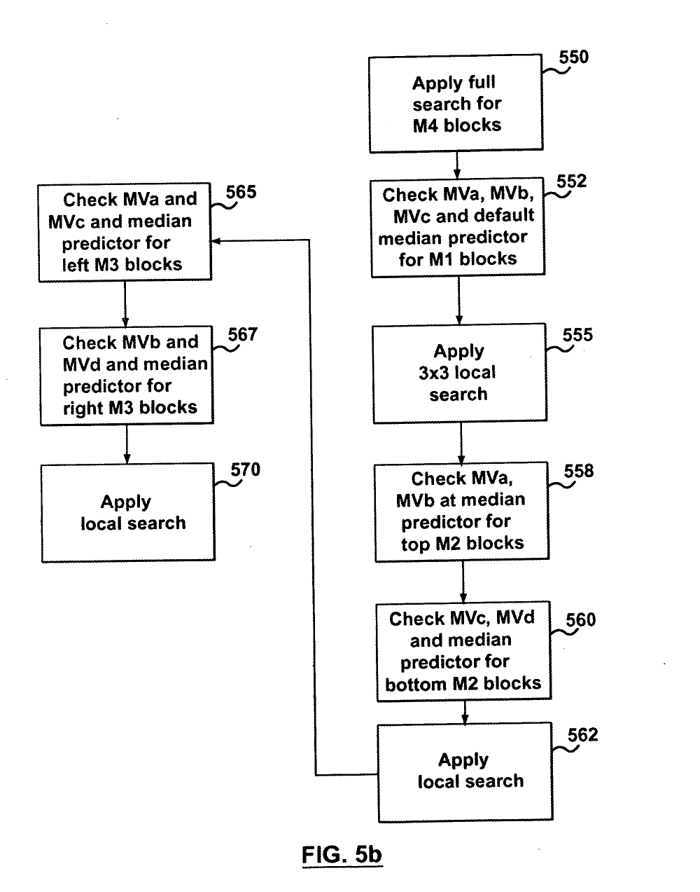

Referring to FIG. 5(a), integer-pixel motion estimation is performed (500) on the 8×8 block size of mode 4 first to obtain (502) four optimal motion vectors MV1, MV2, MV3 and MV4 for the four 8×8 blocks. Then the four motion vectors are examined. If the four motion vectors from the four 8×8 sub-blocks are identical (508), mode 1 (16×16) is chosen (510) with the corresponding common motion vector MV1. It is also possible, for example, to take the average of MV1, MV2, MV3, and MV4. An optimal sub-pixel motion estimation can be applied. If only three of the motion vectors are equal and the fourth motion vector is within a certain distance, such as 1, as in decision step 512, the block size is still chosen to be 16×16 (mode 1) and the motion vector is chosen to be the dominant motion vector. An optional local motion estimation can be performed for better performance. If the collocated macroblock in the previous frame is mode 1, and all 8×8 motion vectors have magnitude less than a threshold (e.g. 1), and all 8×8 motion vectors have the same direction (515), then the block size is again chosen to be 16×16. Integer-pixel motion estimation is performed on a small local neighbourhood (e.g. a 3×3 window) followed by sub-pixel motion estimation. If the x-components or y-components of the 8×8 MVs have large magnitude, such as greater than or equal to 3, as in decision step 518, the block size is chosen to be 16×16 (mode 1) and motion estimation is performed on a small local neighborhood (e.g. a 5×5 window) followed by sub-pixel motion estimation. When the motion is large, it is likely to be a fast-moving situation with motion blurring in which the smaller block size tends not to be particularly useful. After the four decisions, if Mode 1 is not chosen, then Mode 2 and Mode 3 are examined (520).

The proposed FMBMW-1 was implemented in the H.264 reference software JM6.1e: Spiral Full Search is used in the motion estimation for individual block size, such as 8×8, 8×16, and 8×16. Some simulation results on the video sequences “Mobile,” “Children,” “Stefan,” and “Foreman are shown in Tables 3, 4, 5, and 6 below respectively. The average PSNR loss of the proposed FMBME2-1 compared to full search of all block size is only 0.014 dB with an average bit-rate increase of 0.74%, which is small. The average number of searched block sizes for FMBME2-1 is 1.7 blocks instead of 4 block sizes in the Full Search Scheme.

TABLE 3
Simulation results of Bottom-Up FMBME2-1 on “Mobile”
Mobile QCIF

| | FMBME2-1 | | Full Search | | | BR |
|---|---|---|---|---|---|---|
| QP | Psnr(dB) | BR (kbits) | Psnr(dB) | BR (kbits) | Gain(dB) | Gain |
| 10 | 49.28 | 2901.17 | 49.28 | 2900 | 0 | −0.04% |
| 12 | 47.29 | 2494.08 | 47.3 | 2493.73 | −0.01 | −0.01% |
| 14 | 45.64 | 2154.72 | 45.64 | 2154.29 | 0 | −0.02% |
| 16 | 43.87 | 1839.74 | 43.88 | 1839.04 | −0.01 | −0.04% |
| 18 | 41.82 | 1504.98 | 41.82 | 1503.68 | 0 | −0.09% |
| 20 | 40.03 | 1234.99 | 40.04 | 1233.39 | −0.01 | −0.13% |
| 22 | 38.34 | 1003.05 | 38.34 | 1002.26 | 0 | −0.08% |
| 24 | 36.3 | 764.29 | 36.3 | 763.11 | 0 | −0.15% |
| 26 | 34.53 | 581.04 | 34.53 | 579.38 | 0 | −0.29% |
| 28 | 32.79 | 430.46 | 32.79 | 429.78 | 0 | −0.16% |
| 30 | 30.88 | 306.63 | 30.89 | 305.26 | −0.01 | −0.45% |
| 32 | 29.16 | 215.65 | 29.16 | 214.44 | 0 | −0.56% |
| 34 | 27.63 | 153.93 | 27.65 | 152.93 | −0.02 | −0.65% |
| 36 | 26.01 | 103.36 | 26.04 | 102.86 | −0.03 | −0.49% |
| 38 | 24.59 | 73.66 | 24.62 | 73.14 | −0.03 | −0.71% |
| 40 | 23.34 | 54.65 | 23.37 | 54.16 | −0.03 | −0.90% |
| | | | | Average | −0.01 | −0.30% |

TABLE 4
Simulation results of Bottom-Up FMBME2-1 on “Children”
Children QCIF

| | FMBME2-1 | | Full Search | | | BR |
|---|---|---|---|---|---|---|
| QP | Psnr(dB) | BR (kbits) | Psnr(dB) | BR (kbits) | Gain(dB) | Gain |
| 10 | 50.14 | 1119.72 | 50.15 | 1116.16 | −0.01 | −0.32% |
| 12 | 48.31 | 972.09 | 48.33 | 970.49 | −0.02 | −0.16% |
| 14 | 46.66 | 857.54 | 46.67 | 858.23 | −0.01 | 0.08% |
| 16 | 44.97 | 751.94 | 44.99 | 751.75 | −0.02 | −0.03% |
| 18 | 43.03 | 633.11 | 43 | 632.76 | 0.03 | −0.06% |
| 20 | 41.34 | 540.78 | 41.3 | 540.68 | 0.04 | −0.02% |
| 22 | 39.7 | 460.86 | 39.72 | 460.74 | −0.02 | −0.03% |
| 24 | 37.84 | 377.21 | 37.85 | 376.3 | −0.01 | −0.24% |
| 26 | 36.23 | 309.95 | 36.23 | 309.42 | 0 | −0.17% |
| 28 | 34.73 | 252.58 | 34.69 | 251.75 | 0.04 | −0.33% |
| 30 | 32.97 | 203.33 | 32.97 | 202.68 | 0 | −0.32% |
| 32 | 31.34 | 160.06 | 31.3 | 159.12 | 0.04 | −0.59% |
| 34 | 29.85 | 127.5 | 29.84 | 126.69 | 0.01 | −0.64% |
| 36 | 28.2 | 95.22 | 28.22 | 94.33 | −0.02 | −0.94% |
| 38 | 26.71 | 73.37 | 26.75 | 72.78 | −0.04 | −0.81% |
| 40 | 25.38 | 56.8 | 25.36 | 56.35 | 0.02 | −0.80% |
| | | | | Average | 0.00 | −0.34% |

TABLE 5
Simulation results of Bottom-Up FMBME2-1 on “Stefan”
Stefan QCIF

| | FMBME2-1 | | Full Search | | | BR |
|---|---|---|---|---|---|---|
| QP | Psnr(dB) | BR (kbits) | Psnr(dB) | BR (kbits) | Gain(dB) | Gain |
| 10 | 49.48 | 2602.94 | 49.48 | 2600.02 | 0 | −0.11% |
| 12 | 47.64 | 2203.31 | 47.64 | 2201.34 | 0 | −0.09% |
| 14 | 46.13 | 1891.53 | 46.14 | 1889.58 | −0.01 | −0.10% |
| 16 | 44.48 | 1611.5 | 44.48 | 1608.48 | 0 | −0.19% |
| 18 | 42.58 | 1323.53 | 42.58 | 1321.57 | 0 | −0.15% |
| 20 | 40.89 | 1095.21 | 40.89 | 1092.23 | 0 | −0.27% |
| 22 | 39.3 | 903.06 | 39.3 | 900.83 | 0 | −0.25% |
| 24 | 37.36 | 707.5 | 37.36 | 705.61 | 0 | −0.27% |
| 26 | 35.65 | 557.72 | 35.66 | 555.8 | −0.01 | −0.35% |
| 28 | 33.95 | 432.34 | 33.96 | 430.4 | −0.01 | −0.45% |
| 30 | 32.06 | 322.08 | 32.07 | 320.79 | −0.01 | −0.40% |
| 32 | 30.34 | 238.65 | 30.34 | 236.84 | 0 | −0.76% |
| 34 | 28.79 | 177.98 | 28.8 | 177.61 | −0.01 | −0.21% |
| 36 | 27.13 | 127.37 | 27.13 | 127.04 | 0 | −0.26% |
| 38 | 25.66 | 94.1 | 25.68 | 93.35 | −0.02 | −0.80% |
| 40 | 24.33 | 70.58 | 24.36 | 70.23 | −0.03 | −0.50% |
| | | | | Average | −0.00625 | −0.32% |

TABLE 6
Simulation results of Bottom-Up FMBME2-1 on “Foreman”
ForemanQCIF

| | FMBME2-1 | | Full Search | | | BR |
|---|---|---|---|---|---|---|
| QP | Psnr(dB) | BR (kbits) | Psnr(dB) | BR (kbits) | Gain(dB) | Gain |
| 10 | 49.69 | 1457.15 | 49.69 | 1455.02 | 0 | −0.15% |
| 12 | 47.97 | 1149.21 | 47.97 | 1146.8 | 0 | −0.21% |
| 14 | 46.5 | 923.26 | 46.5 | 921.76 | 0 | −0.16% |
| 16 | 44.89 | 732.14 | 44.9 | 729.57 | −0.01 | −0.35% |
| 18 | 43.11 | 552.33 | 43.12 | 550.69 | −0.01 | −0.30% |
| 20 | 41.52 | 422.31 | 41.53 | 419.7 | −0.01 | −0.62% |
| 22 | 40.03 | 328.54 | 40.03 | 326.17 | 0 | −0.73% |
| 24 | 38.32 | 241.99 | 38.33 | 238.92 | −0.01 | −1.28% |
| 26 | 36.83 | 180.03 | 36.85 | 178.54 | −0.02 | −0.83% |
| 28 | 35.48 | 136.92 | 35.49 | 135.35 | −0.01 | −1.16% |
| 30 | 33.99 | 103.02 | 34 | 101.24 | −0.01 | −1.76% |
| 32 | 32.57 | 77.65 | 32.58 | 76.58 | −0.01 | −1.40% |
| 34 | 31.3 | 60.67 | 31.34 | 59.62 | −0.04 | −1.76% |
| 36 | 29.96 | 45.86 | 30.03 | 45.43 | −0.07 | −0.95% |
| 38 | 28.63 | 35.55 | 28.71 | 35.47 | −0.08 | −0.23% |
| 40 | 27.49 | 28.63 | 27.53 | 28.3 | −0.04 | −1.17% |
| | | | | Average | −0.02 | −0.82% |

Another implementation of the invention is called FMBME2-2 for another bottom-up approach with smaller block size being 8×8 and larger block sizes being 16×16, 16×8 and 8×16. This approach was presented in the paper A. Chang, P. H. W. Wong, O. C. Au, Y. M. Yeung, “Fast Integer Motion Estimation for H.264 Video Coding Standard”, Proc. of IEEE Int. Conf on Multimedia & Expo, Taipei, Taiwan, June 2004, the entire content of which is hereby incorporated by reference.

In the design, we obtain for each 8×8 sub-block the optimal motion vector and SAD value. In our experiments, we find that there exists a high correlation between the 8×8 motion vectors and the optimal motion vector for larger block sizes, i.e. 16×16, 8×16 and 16×8 block sizes. In the proposed fast integer motion estimation, full search is first performed for 8×8 block sizes. Each 8×8 motion vector (in quarter pixel accuracy) will be rounded to integer motion vector and used as the initial search point for Mode 1, 2 and 3.

Table 7 shows the hit-rate when the integer motion vector as well as the sub-pel motion vector of 8×8 sub-block 0, 1, 2 and 3 and the 16×16 optimal integer and sub-pel motion vector are exactly the same. We can see that the hit-rate is very high which indicate that 8×8 motion vectors are very good predictors for 16×16 ME.

| | Integer | Sub-pixel |
|---|---|---|
| | pixel motion | motion |
| | vectors | vectors |
| Foreman | 93% | 76.6% |
| QCIF | | |
| Stefan | 90% | 82.6% |
| QCIF | | |

Table 7 Percentage of 8×8 optimal integer and sub-pixel motion vectors being equal to corresponding 16×16 optimal integer and sub-pixel motion vectors

Furthermore, FIG. 6 shows the distribution of the motion vector difference between the best 8×8 integer motion vector obtained from 8×8 motion estimation and the optimal integer motion vector obtained from 16×16 motion estimation. The testing sequence “Foreman” with QCIF format is used in the experiments. We can see that the distance between 8×8 and 16×16 motion vectors tend to be very small implying that they tend to be very close to each other. Accordingly, if a 16×16 local search (motion estimation) is performed around the 8×8 motion vector, it is very likely that we can obtain the optimal motion vector for 16×16 block size.

It is further observed that the relationship between optimal vectors of Mode 3 (103) and the optimal 8×8 motion vectors is similar to that of Mode 1 (101). However, for Mode 2 (102), there is some problem in directly using 8×8 motion vectors as the predictor for the top or bottom sub-blocks in Mode 2.

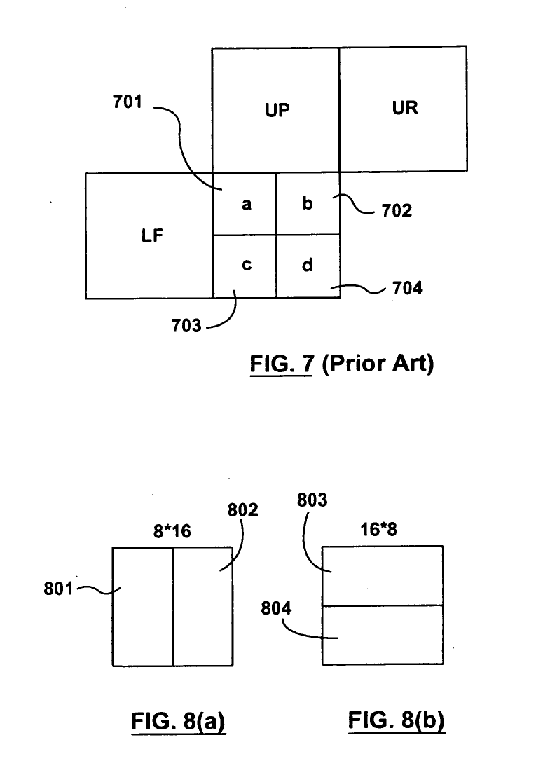

In H.264, for each sub-block in different Modes a predicted motion vector is calculated base on the surrounding motion vector information. This motion vector predictor will act as the search center of the current sub-block. The optimal motion vector obtained after motion estimation will be subtracted from this motion vector predictor to get the motion vector difference which will be encoded and sent to the decoder. In H.264, the predictors for 8×8 motion vectors are obtained using median prediction as shown in FIG. 7. The predictors for 8×8 motion vectors MVₐ, MV_{b}, MV_{c} and MV_{d} for subblock a (701), b (702), c (703), and d (704) are:
predictMVₐ=median(MV_{UP}, MV_{UR}, MV_{LF})
predictMV_{b}=median(MV_{UP}, MV_{UR}, MVₐ)
predictMV_{c}=median(MVₐ, MV_{b}, MV_{LF})
predictMV_{d}=median(MVₐ, MV_{b}, MV_{c})

However, the motion vector predictors for Mode 2 (16×8) and Mode 3 (8×16) are obtained in a different way. Instead of using median prediction, H.264 makes use of the directional segmentation prediction to get the motion vector predictor for the current sub-block. For example, in FIG. 8(a), the left sub-block 801 in Mode 3 will use MV_{LF} as the predictor and the right sub-block 802 will use MV_{UR}. Similarly the top sub-block 803 in Mode 2 in FIG. 8(b) will use MV_{UP} as the predictor and the bottom sub-block 804 will use MV_{LF}.

In the situation where the current macroblock should be segmented horizontally, the upper sub-block and lower sub-block of the macroblock may belong to two different objects and would tend to move in different directions. If this is true. the predictMV_{c} and predictMV_{d} may not be good predictors for MV_{c} and MV_{d} respectively. Note that the definitions of both predictMV_{c} and predictMV_{d} are dominated by MVₐ and MV_{b} due to the median definition, especially when MVₐ and MV_{b} are similar. This can reduce the accuracy of 8×8 predictors of MV_{c} and MV_{d} because, if MVₐ and MV_{b} refer to the object in the upper sub-block, the predictMV_{c} and predictMV_{d} would be dominated by MVₐ and MV_{b} and may not be close to the true MV_{c} and MV_{d}, especially when the motion difference between upper and lower sub-blocks of the macroblock is very large. As a result, predictMV_{c} and predictMV_{d} are not suitable to predict the motion vectors MV_{c} and MV_{d} for the lower sub-block of macroblock in Mode 1. We found that this situation can be helped by including the predictor for Mode 2 in our algorithm.

Referring to FIG. 5(b), in the proposed FMBME2-2, full search (or some fast search) is first performed for 8×8 Mode 4 block size (550). Each 8×8 motion vector in quarter pixel precision will be rounded to integer precision and used as the initial search point for Modes 1, 2 and 3.

For Mode 1, the SAD value for integer precision motion vector MVₐ, MV_{b}, MV_{c} and the default median predictor are computed (552). Among these four MV's, the best is chosen as the center around which eight neighboring locations are examined (555) in search of the least SAD. The search for Mode 2 and Mode 3 are similar to Mode 1 except that the upper sub-block of Mode 2 will use MVₐ, MV_{b} and the median predictor (558) whereas the lower sub-block will use MV_{c}, MV_{d} and the median predictor (560). A local search is then conducted (562). Similarly, in step 565 the motion vector of the left sub-block in Mode 3 will be predicted by MVₐ, MV_{c} and the median whereas the right sub-block will use MV_{b}, MV_{d} and the median predictor (567).

The proposed FMBME2-2 algorithm was implemented in the reference JVT software version 7.3. The proposed bottom-up FMBME2-2 can reduce computational cost by 69.7% on average (equivalent complexity of performing motion estimation on 1.2 block types instead of 4 block types) with negligibly small PSNR degradation (0.005 dB) and a slight increase in bit rate (0.045%).

TABLE 9
PSNR and Bitrate Comparison between proposed bottom-up FMBME2-2
and FS with QP = 14 to 36 (a) Akiyo (b) Coastguard (c) Stefan (d) Foreman

| | FMBME2-2 | | | Full Search | | | | | |
|---|---|---|---|---|---|---|---|---|---|
| QP | PSNR | BR(total) | IME time | PSNR | BR(total) | IME time | Gain(dB) | BR Drop | Complexity |

Akiyo QCIF
(a) Akiyo QCIF

| | | | | | | | | | |
|---|---|---|---|---|---|---|---|---|---|
| 14 | 48.1 | 1976792 | 10.68 | 48.1 | 1976792 | 29.96 | 0 | 0.00% | −64.36% |
| 16 | 46.75 | 1557256 | 7.84 | 46.75 | 1557256 | 26.07 | 0 | 0.00% | −69.92% |
| 18 | 45.19 | 1101736 | 8.99 | 45.19 | 1101736 | 28.61 | 0 | 0.00% | −68.59% |
| 20 | 43.77 | 837216 | 7.40 | 43.78 | 837920 | 25.96 | −0.01 | 0.08% | −71.48% |
| 22 | 42.4 | 637440 | 8.35 | 42.4 | 637440 | 29.14 | 0 | 0.00% | −71.34% |
| 24 | 40.77 | 462232 | 7.76 | 40.76 | 462960 | 28.08 | 0.01 | 0.16% | −72.37% |
| 26 | 39.37 | 335456 | 7.40 | 39.37 | 335624 | 27.75 | 0 | 0.05% | −73.33% |
| 28 | 37.97 | 248496 | 7.39 | 37.98 | 248952 | 27.86 | −0.01 | 0.18% | −73.46% |
| 30 | 36.5 | 183048 | 6.87 | 36.51 | 182976 | 27.16 | −0.01 | −0.04% | −74.69% |
| 32 | 34.96 | 140624 | 7.10 | 34.93 | 140504 | 28.72 | 0.03 | −0.09% | −75.27% |
| 34 | 33.62 | 109624 | 6.45 | 33.58 | 109888 | 27.01 | 0.04 | 0.24% | −76.14% |
| 36 | 32.23 | 85264 | 6.19 | 32.23 | 84568 | 26.78 | 0 | −0.82% | −76.88% |
| | | | | | | Average | 0.00 | −0.02% | −72.32% |

Coastguard QCIF
(b) Coastguard QCIF

| | | | | | | | | | |
|---|---|---|---|---|---|---|---|---|---|
| 14 | 45.84 | 1.3E+07 | 15.56 | 45.84 | 12930128 | 45.76 | 0 | −0.03% | −66.00% |
| 16 | 44.11 | 1.1E+07 | 14.93 | 44.11 | 10675808 | 45.15 | 0 | 0.05% | −66.93% |
| 18 | 42.17 | 8335880 | 15.26 | 42.17 | 8335496 | 46.86 | 0 | 0.00% | −67.44% |
| 20 | 40.47 | 6576336 | 15.30 | 40.47 | 6581304 | 47.14 | 0 | 0.08% | −67.55% |
| 22 | 38.86 | 5163384 | 16.07 | 38.85 | 5163736 | 49.70 | 0.01 | 0.01% | −67.67% |
| 24 | 37.01 | 3778616 | 17.16 | 37 | 3780104 | 51.62 | 0.01 | 0.04% | −66.77% |
| 26 | 35.38 | 2772320 | 16.96 | 35.39 | 2771312 | 53.97 | −0.01 | −0.04% | −68.58% |
| 28 | 33.88 | 2002008 | 17.12 | 33.89 | 2000976 | 56.56 | −0.01 | −0.05% | −69.73% |
| 30 | 32.27 | 1380696 | 16.99 | 32.26 | 1377664 | 58.48 | 0.01 | −0.22% | −70.95% |
| 32 | 30.77 | 948632 | 17.08 | 30.79 | 950616 | 60.83 | −0.02 | 0.21% | −71.93% |
| 34 | 29.46 | 676744 | 16.55 | 29.47 | 676616 | 61.39 | −0.01 | −0.02% | −73.04% |
| 36 | 28.1 | 460424 | 16.00 | 28.13 | 458336 | 62.24 | −0.03 | −0.46% | −74.29% |
| | | | | | | Average | 0.00 | −0.04% | −69.24% |

Foreman QCIF
(c) Stefan QCIF

| | | | | | | | | | |
|---|---|---|---|---|---|---|---|---|---|
| 14 | 46.5 | 9132312 | 15.14 | 46.5 | 9145768 | 43.90 | 0 | 0.15% | −65.51% |
| 16 | 44.89 | 7228912 | 14.39 | 44.89 | 7230304 | 42.77 | 0 | 0.02% | −66.36% |
| 18 | 43.11 | 5442992 | 14.78 | 43.1 | 5455400 | 43.99 | 0.01 | 0.23% | −66.39% |
| 20 | 41.52 | 4151376 | 14.33 | 41.52 | 4161928 | 43.46 | 0 | 0.25% | −67.01% |
| 22 | 40.03 | 3221368 | 14.91 | 40.03 | 3228888 | 45.14 | 0 | 0.23% | −66.97% |
| 24 | 38.33 | 2360040 | 14.72 | 38.33 | 2364376 | 45.44 | 0 | 0.18% | −67.60% |
| 26 | 36.86 | 1766984 | 14.53 | 36.85 | 1764488 | 46.04 | 0.01 | −0.14% | −68.43% |
| 28 | 35.5 | 1333032 | 14.42 | 35.51 | 1332320 | 46.81 | −0.01 | −0.05% | −69.18% |
| 30 | 34.01 | 1001072 | 13.84 | 34.01 | 999664 | 46.79 | 0 | −0.14% | −70.43% |
| 32 | 32.58 | 763248 | 13.66 | 32.61 | 759040 | 47.54 | −0.03 | −0.55% | −71.28% |
| 34 | 31.33 | 599776 | 12.77 | 31.35 | 597168 | 46.99 | −0.02 | −0.44% | −72.81% |
| 36 | 29.93 | 460192 | 12.51 | 29.95 | 460928 | 47.25 | −0.02 | 0.16% | −73.53% |
| | | | | | | Average | −0.01 | −0.01% | −68.79% |

Foreman QCIF
(d) Foreman QCIF

| | | | | | | | | | |
|---|---|---|---|---|---|---|---|---|---|
| 14 | 46.13 | 1.9E+07 | 17.88 | 46.13 | 18787632 | 53.0848 | 0 | −0.09% | −66.31% |
| 16 | 44.47 | 1.6E+07 | 17.07 | 44.48 | 15997512 | 51.8612 | −0.01 | −0.07% | −67.08% |
| 18 | 42.58 | 1.3E+07 | 17.27 | 42.57 | 13133424 | 52.6699 | 0.01 | −0.09% | −67.22% |
| 20 | 40.88 | 1.1E+07 | 16.94 | 40.89 | 10850992 | 51.817 | −0.01 | −0.11% | −67.32% |
| 22 | 39.29 | 8949992 | 16.91 | 39.3 | 8949168 | 52.435 | −0.01 | −0.01% | −67.74% |
| 24 | 37.35 | 7002320 | 16.34 | 37.35 | 7002664 | 51.9652 | 0 | 0.00% | −68.55% |
| 26 | 35.64 | 5516936 | 16.18 | 35.65 | 5510080 | 51.8773 | −0.01 | −0.12% | −68.81% |
| 28 | 33.94 | 4275176 | 16.00 | 33.95 | 4263592 | 52.003 | −0.01 | −0.27% | −69.22% |
| 30 | 32.06 | 3183920 | 15.70 | 32.06 | 3175976 | 52.0936 | 0 | −0.25% | −69.87% |
| 32 | 30.32 | 2350648 | 15.81 | 30.35 | 2348624 | 52.5538 | −0.03 | −0.09% | −69.92% |
| 34 | 28.78 | 1762120 | 15.58 | 28.8 | 1757504 | 52.7386 | −0.02 | −0.26% | −70.45% |
| 36 | 27.14 | 1258728 | 15.63 | 27.15 | 1258888 | 54.2714 | −0.01 | 0.01% | −71.20% |
| | | | | | | Average | −0.01 | −0.11% | −68.64% |

Yet there is another implementation of the bottom-up invention which we call FMBME2-3 for the bottom-up approach with smaller block size being 8×8 and larger block sizes being 16×16, 16×8 and 8×16. It is basically FMBME2-2 with fast motion estimation applied to the 8×8 block size. In FMBME2-2, the computational bottleneck is the 8×8 motion estimation (ME) in which Full Search is used. As a result, if the 8×8 Full Search ME can be replaced by a fast ME, the overall performance can be greatly increased. Our 8×8 fast ME in FMBME2-3 follows the idea of PMVFAST, in which some MV predictors are searched before one of them is chosen as center for some local search. The MV predictors included MV_{UP}, MV_{UR}, MV_{LF}, median(MV_{UP}, MV_{UR}, MV_{LF}) and MV_{co} (motion vector of the collocated block in previous or reference frame). The SAD values of the predictors are calculated and the one with minimum SAD value is chosen as the center for local search. There are two early termination criteria based on the SAD
i) If current SAD<minimum(SAD_{UP}, SAD_{UR}, SAD_{LF}), stop.
ii) If chosen MV predictor is equal to MV_{co} and current SAD<SAD_{co}, stop.

If early termination is not successful, small or large diamond search is performed around the chosen MV predictor.

The proposed FMBME2-3 is implemented in the reference JVT software version 7.3. Compared with spiral FS, the proposed FMBME2-3 can reduce computational complexity by 90% on the average (which depends on QP and sequences) with negligibly small PSNR degradation (e.g. 0.03 dB) and a possible reduction of bit-rate (e.g. 1%).

The Bottom-up FMBME2-1, FMBME2-2 and FMBME2-3 can be extended to compute the 4×4 ME first and use the SAD and MV information for all the other block types. The correlation between 4×4 ME result and other block type can then be exploited. In FMBME2-1, FMBME2-2, and FMBME2-3, we divide a 16×16 block into four 8×8 blocks. We perform relatively complicated ME on the four 8×8 blocks first. As the MV of the four 8×8 blocks are available, we then perform simplified search on two 8×16, two 16×8 and one 16×16 blocks.

To generalize them, we can divide a 16×16 macroblock into four 8×8 blocks. And we further divide each 8×8 block into four 4×4 blocks. For each 8×8 block, we can use the 3 methods to perform relativey complicated ME on four 4×4 blocks first, and then perform simplified search on two 4×8, two 8×4 and one 8×8 blocks. With MV for each 8×8 block, we can again perform simplified search on two 8×16, two 16×8 and one 16×16 blocks.

The Bottom-up FMBME2-1, FMBME2-2, and FMBME2-3 can also be extended to use some function of the 4 motion vectors in 8×8 ME as a predictor for larger block-size motion estimation. For example linear combination of MV (weighted average) based on the SAD value.

Combination of Bottom-Up FMBME2-1, and FMBME2-2 is obviously possible. Similarly, combination of FMBME2-1 and FMBME2-3 is also possible.

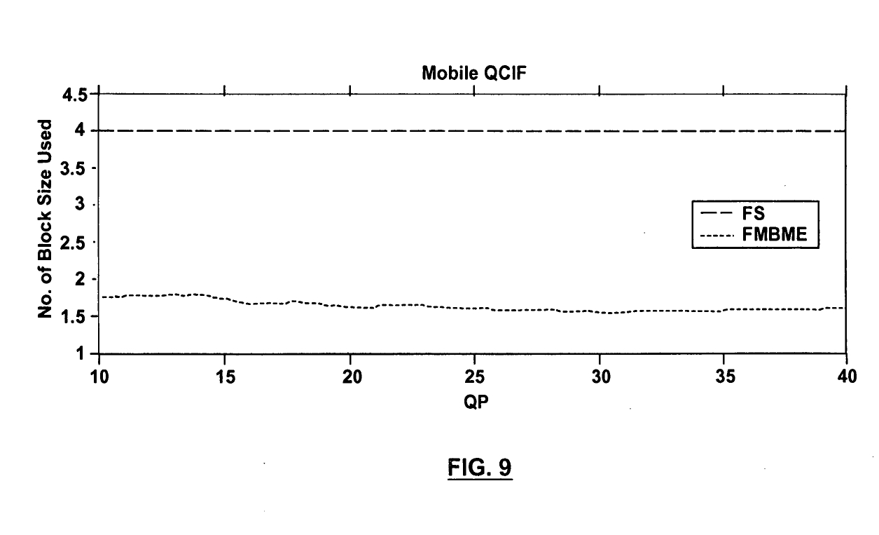

FIG. 9 illustrates another graphical view of performance comparison for the Mobile QCIF between a full search, which is equivalent to performing motion estimation on 4 blocks, and the FMBME which has the equivalent complexity of perfoming motion estimation on about 1.7 block types.

The General Aspect

The Top-Down FMBME can be combined with the Bottom-Up FMBME2-1, FMBME2-2 or FMBME2-3. This is a general aspect of fast multiple block-size motion estimation and is referred to as FMBME3. In FMBME3, instead of starting at the top or the bottom in the hierarchy of modes, we start in the middle and to perform simple search for either or both the higher modes or the lower modes.

For example, initial full search or fast search can be applied to 8×8 block size. The bottom-up approach can be used for fast ME for 16×16, 16×8 and 8×16 block size. The top-down approach can be used for fast ME for 8×4, 4×8 and 4×4 block size. First, select first image frame called “current frame” against a reference image frame called “reference frame”, including
h. defining regions called “macroblocks” (e.g. non-overlapping rectangular blocks of size 16×16) in the current frame and their corresponding locations (e.g. location of a macroblock may be its upper left corner within the current frame);
i. for each macroblock called “current macroblock” in the current frame, defining a search region (e.g. a search window of 32×32) in the reference frame, with each point called “search point” in the search region corresponding to a motion vector called “candidate motion vector” which is the relative displacement between the current macroblock and a candidate macroblock in the reference frame; search regions for different macroblock in the current frame may have different sizes and shape;
j. for each current macroblock, constructing a hierarchy called “modes” or “levels” of possible subdivision of the macroblock into smaller non-overlapping regions or “sub-blocks” (e.g. a 16×16 macroblock can be subdivided into one 16×16 sub-block in mode 1, and two 16×8 sub-blocks in mode 2, and two 8×16 sub-blocks in mode 3, and four 8×8 sub-blocks in mode 4, and eight 8×4 sub-blocks in mode 5, and eight 4×8 sub-blocks in mode 6, and sixteen sub-blocks in mode 7, etc) where the “modes” or “levels” are enumerated such that level M has sub-blocks with smaller area than or equal to those of level N for M>N;

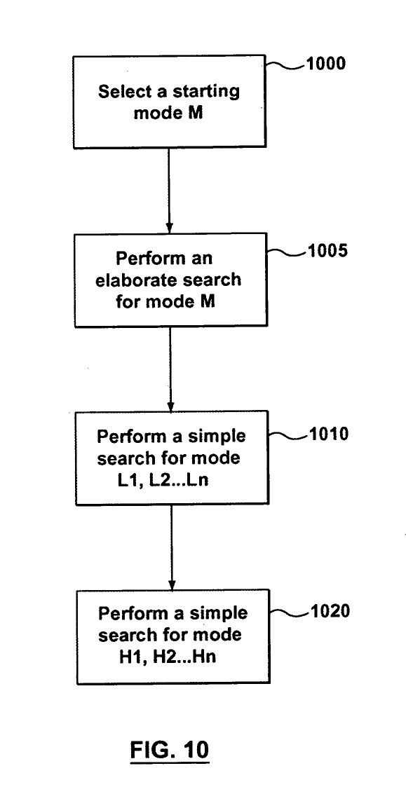

Referring to FIG. 10, to start the process, first a starting mode M is selected (1000). Mode M is somewhere in the middle among the hierarchy of modes for dividing the macroblock. For each current macroblock in the current frame, perform (1005) a relatively elaborate search (which may be brute-force exhaustive search or some fast search such as PMVFAST) with respect to some mismatch. Then, a relatively simple search can be performed for either or both the lower modes (1010) and the higher modes (1020) of macroblock subdivision.

While H.264 allows 7 block size (16×16, 16×8, 8×16, 8×8, 8×4, 4×8, 4×4), other block size can also be used for our invention. The blocks do not necessarily have to be non-overlapping. While H.264 allows integer-pixel, half-pixel and quarter-pixel precision for motion vectors, the invention can be applied for other sub-pixel precision motion vectors. This invention can be applied with multiple reference frames, and the fast search can be different for different reference frames. The reference frames may be in the past or in the future. While only one of the candidate reference frames is used in H.264, more than one frames can be used (e.g. a linear combination of several reference frames). While H.264 uses discrete cosine transform, any discrete transform can be applied. While video is a sequence of “frames” which are 2-dimensional pictures of the world, the invention can be applied to sequences of lower (e.g. 1) or higher (e.g. 3) dimensional description of the world.

It is to be noted that the present invention is illustrated above with examples of encoding of video; however, its various aspect are not restricted to the encoding of video, but are also applicable to the correspondence estimation in the encoding of audio signals, speech signals, video signals, seismic signals, medical signals, etc. Similarly, a typical computer-readable medium is broadly defined to include any kind of computer memory such as floppy disks, conventional hard disks, CD-ROMs, flash ROMS, non-volatile ROM and RAM, and the like according to the state of the art.

What I claim is:

1. In a data compressing scheme for matching between frames of images in which each frame is divided into a predetermined number of macroblocks, a method of choosing the best mode for dividing a candidate macroblock from among the predetermined number of macroblocks for motion estimation, said method comprising:
defining a motion vector for a search point in a research region within the candidate macroblock;
constructing a hierarchy of modes for subdividing the candidate macroblock into one or more subblocks wherein the modes are enumerated such that a mode M comprises subblocks with smaller area than or equal to sublocks of a mode N if M>N;
selecting a lowest mode L and performing an elaborate search with respect to a mismatch measure for the mode L;
choosing the mode M for dividing the candidate macroblock if the mismatch measure is smaller than a threshold; and
performing a relatively simple search for higher modes if the mismatch is not smaller than a threshold.

2. The method of claim 1 wherein the mismatch measure comprises sum of absolute difference (SAD).

3. The method of claim 2 wherein the threshold comprises a weighted average of minimum SADs from among neighbouring blocks.

4. The method of claim 3 wherein the threshold comprises a non-linear function of a weighted average of SADs.

5. The method of claim 1 wherein the elaborated search for the mode L has integer-pixel precision.

6. The method of claim 5 further comprising performing a sub-pixel motion estimation.

7. The method of claim 1 wherein performing the relatively simple search for the higher modes if the mismatch is not smaller than the threshold comprises performing the relatively simple search for a subset of the higher modes in the hierarchy of modes for subdividing the candidate macroblock.

8. The method of claim 1 wherein an elaborate search comprises a search which exhaustively searches candidate motion vectors.

9. The method of claim 1 wherein a relatively simple search comprises a local search which searches candidate motion vectors only within a small neighbourhood of a motion vector from lower modes.

10. The method of claim 1 wherein the mode L comprises one 16×16 subblock in the candidate macroblock.

11. The method of claim 10 further comprising performing a half-pixel motion estimation for a mode 2 with two 16×8 subblocks and a mode 3 with two 8×16 subblocks around a best integer-pixel motion vector from the mode L if a smallest mismatch measure of the best integer-pixel motion vector in the mode L is larger than the threshold.

12. The method of claim 11 further comprising choosing the mode 2 if a sum of the two 16×8 sub-blocks is smaller than a sum of the two 8×16 sub-blocks of mode 3 with a corresponding best sub-pixel motion vector.

13. In a data compressing scheme for matching between frames of images in which each frame is divided into a predetermined number of macroblocks, a method of choosing the best mode for dividing a candidate macroblock from among the predetermined number of macroblocks for motion estimation, said method comprising:
defining a motion vector for a search point in a research region within the candidate macroblock;
constructing a hierarchy of modes for subdividing the candidate macroblock into one or more subblocks wherein the modes are enumerated such that a mode M comprises subblocks with smaller area than or equal to sublocks of a level N if M>N;
selecting a highest mode H and performing an elaborate search with respect to a mismatch measure for the mode H; and
performing a relatively simple search for modes lower than H.

14. The method according to claim 13 wherein the mode H comprises mode 4 and the candidate macroblock comprises a 16×16 block.

15. The method according to claim 14, further comprising:
Performing integer level motion estimation on mode 4 subblocks;
Obtaining four motion vectors MV1, MV2, MV3, MV4 one for each of the mode 4 subblocks; and
Selecting mode 1 with MV1 if MV1, MV2, MV3 and MV4 are equal.

16. The method according to claim 14, further comprising:
Performing integer level motion estimation on mode 4 subblocks;
Obtaining four motion vectors MV1, MV2, MV3, MV4 one from each of the mode 4 subblocks; and
Selecting mode 1 with MV1 If only MV1, MV2 and MV3 are equal and MV4 is within a threshold distance.

17. The method of claim 16 wherein the threshold distance comprises 1 integer distance.

18. The method according to claim 14, further comprising:
Performing integer level motion estimation on mode 4 subblocks;
Obtaining four motion vectors MV1, MV2, MV3, MV4 one from each of the mode 4 subblocks; and
Selecting mode 1 if MV1, MV2, MV3 and MV4 have a magnitude smaller than a first threshold magnitude, have the same direction, and a collocated macroblock of the candidate macroblock in a previous frame is mode 1.

19. The method according to claim 18 wherein the first threshold magnitude comprises 1.

20. The method according to claim 14, further comprising:
Performing integer level motion estimation on mode 4 subblocks;
Obtaining four motion vectors MV1, MV2, MV3, MV4 one from each of the mode 4 subblocks; and
Selecting mode 1 if x-components or y-components of MV1, MV2, MV3, and MV4 are larger than a second threshold magnitutde.

21. The method according to claim 20 wherein the second threshold magnitude comprises 3.

22. A method for fast multi-block motion estimation, comprising:
a. selecting a macroblock in a current frame and obtaining a motion vector;
b. constructing a hierarchy of levels for subdividing the macroblock into one or more smaller non-overlapping sub-blocks wherein the levels are enumerated such that a level M has sub-blocks with smaller area than or equal to those of a level N for M>N;
c. performing a relatively elaborate search with respect to a mismatch measure for a level L around a middle in the hierarchy of levels for subdivision of the macroblock; and
d. performing a relatively simple search for levels higher and lower than the level in the hierarchy of levels.

23. A method for fast mult-block motion estimation, comprising:
a. performing a full search with respect to a candidate block;
b. performing a complicated motion estimation on the candidate block; and
c. performing a simplified search on blocks larger than the candidate block using motion vectors from the candidate block as a predictor

24. The method according to claim 23, wherein the search with respect to the candidate block comprises a full search.

25. The method according to claim 23, wherein the search with respect to the candidate block comprises a fast search.

26. A computer-readable storage medium tangibly embodying computer-executable instructions for choosing a best mode for dividing a candidate macroblock from among the predetermined number of macroblocks for motion estimation in matching between frames of images, the program instructions including instructions operable for causing a computer to:
define a motion vector for a search point in a research region within the candidate macroblock;
construct a hierarchy of modes for subdividing the candidate macroblock into one or more subblocks wherein the modes are enumerated such that a mode M comprises subblocks with smaller area than or equal to sublocks of a mode N if M>N;
select a lowest mode L and perform an elaborate search with respect to a mismatch measure for the mode L;
choose the mode M for dividing the candidate macroblock if the mismatch measure is smaller than a threshold; and
perform a relatively simple search for higher modes if the mismatch is not smaller than a threshold.

27. The computer-readable storage medium of claim 26 wherein the mismatch measure comprises sum of absolute difference (SAD).

28. The computer-readable storage medium of claim 27 wherein the threshold comprises a weighted average of minimum SADs from among neighbouring blocks.

29. The computer-readable storage medium of claim 28 wherein the threshold comprises a non-linear function of a weighted average of SADs.

30. The computer-readable storage medium of claim 26 wherein performing the relatively simple search for the higher modes if the mismatch is not smaller than the threshold comprises performing the relatively simple search for a subset of the higher modes in the hierarchy of modes for subdividing the candidate macroblock.

31. The computer-readable storage medium of claim 26 wherein an elaborate search comprises a search which exhaustively searches candidate motion vectors.

32. The computer-readable storage medium of claim 26 wherein a relatively simple search comprises a local search which searches candidate motion vectors only within a small neighbourhood of a motion vector from lower modes.

33. The computer-readable storage medium of claim 26 wherein the mode L comprises one 16×16 subblock in the candidate macroblock.

34. A computer-readable storage medium tangibly embodying computer-executable instructions for choosing a best mode for dividing a candidate macroblock from among the predetermined number of macroblocks for motion estimation in matching between frames of images, the program instructions including instructions operable for causing a computer to:
define a motion vector for a search point in a research region within the candidate macroblock;
construct a hierarchy of modes for subdividing the candidate macroblock into one or more subblocks wherein the modes are enumerated such that a mode M comprises subblocks with smaller area than or equal to sublocks of a level N if M>N;
select a highest mode H and perform an elaborate search with respect to a mismatch measure for the mode H; and
perform a relatively simple search for modes lower than H.

35. The computer-readable storage medium of claim 34, wherein the mode H comprises mode 4 and the candidate macroblock comprises a 16×16 block.

36. The computer-readable storage medium of claim 35, further comprising instructions operable for causing a computer to:
Perform integer level motion estimation on mode 4 subblocks;
Obtain four motion vectors MV1, MV2, MV3, MV4 one for each of the mode 4 subblocks; and
Select mode 1 with MV1 if MV1, MV2, MV3 and MV4 are equal.

37. The computer-readable storage medium of claim 35, further comprising instructions operable for causing a computer to:
perform integer level motion estimation on mode 4 subblocks;
obtain four motion vectors MV1, MV2, MV3, MV4 one from each of the mode 4 subblocks; and
select mode 1 with MV1 If only MV1, MV2 and MV3 are equal and MV4 is within a threshold distance.

38. The computer-readable storage medium of claim 37 wherein the threshold distance comprises 1 integer distance.

39. The computer-readable storage medium of claim 35, further comprising instructions operable for causing a computer to:
Perform integer level motion estimation on mode 4 subblocks;
Obtain four motion vectors MV1, MV2, MV3, MV4 one from each of the mode 4 subblocks; and
Select mode 1 if MV1, MV2, MV3 and MV4 have a magnitude smaller than a first threshold magnitude, have the same direction, and a collocated macroblock of the candidate macroblock in a previous frame is mode 1.

40. The computer-readable storage medium of claim 39 wherein the first threshold magnitude comprises 1.

41. The computer-readable storage medium of claim 35, further comprising instructions operable for causing a computer to:
Perform integer level motion estimation on mode 4 subblocks;
Obtain four motion vectors MV1, MV2, MV3, MV4 one from each of the mode 4 subblocks; and
Selecting mode 1 if x-components or y-components of MV1, MV2, MV3, and MV4 are larger than a second threshold magnitutde.

42. The computer-readable storage medium of claim 41, wherein the second threshold magnitude comprises 3

43. A computer-readable storage medium tangibly embodying computer-executable instructions for choosing a best mode for dividing a candidate macroblock from among the predetermined number of macroblocks for motion estimation in matching between frames of images, the program instructions including instructions operable for causing a computer to:
a. construct a hierarchy of levels for subdividing the macroblock into one or more smaller non-overlapping sub-blocks wherein the levels are enumerated such that a level M has sub-blocks with smaller area than or equal to those of a level N for M>N;
b. perform a relatively elaborate search with respect to a mismatch measure for a level L around a middle in the hierarchy of levels for subdivision of the macroblock; and
c. perform a relatively simple search for levels higher and lower than the level in the hierarchy of levels.

44. A computer-readable storage medium tangibly embodying computer-executable instructions for choosing a best mode for dividing a candidate macroblock from among the predetermined number of macroblocks for motion estimation in matching between frames of images, the program instructions including instructions operable for causing a computer to:
a. perform a full search with respect to the candidate block;
b. perform a complicated motion estimation on the candidate block;
c. perform a simplified search on blocks larger than the candidate block using motion vectors from the candidate block as a predictor.
